(19) United States
(12) Patent Application Publication
(10) Pub. No.: US 2011/0066546 A1
(43) Pub. Date: Mar. 17, 2011

(54) APPARATUS AND METHOD FOR CALCULATING THE LOWERING OF PERIODIC PAYMENTS WITHIN A LOAN REPAYMENT SCHEDULE

(76) Inventor: CHRISTIAN GILLY, Mahopac, NY (US)

(21) Appl. No.: 12/560,281

(22) Filed: Sep. 15, 2009

(51) Int. Cl. G06Q 40/00

(52) U.S. Cl. 705/38

(57) ABSTRACT

A computer implemented method for calculating loan repayment schedule is disclosed, which may comprise receiving data associated with an initial principal loan amount, an interest rate, and a length of loan term; processing the data using a processor to determine a periodic minimum payment toward the initial principal and the interest, and when the minimum periodic payment is made, a new principal balance is determined by subtracting payment toward principal from the initial principal loan amount, and when a payment in excess of the minimum periodic payment is paid, the new principal balance is calculated by subtracting the excess principal payment and the payment toward principal from the minimum periodic payment from the initial principal; and recalculating a new minimum periodic payment based on remaining time and balance of the loan.

### BACKGROUND OF THE INVENTION

The present invention generally relates to loan programs, and more particularly to methods for loan repayment.

A loan is a type of debt. Like all debt instruments, a loan entails the redistribution of financial assets over time, between the lender and the borrower. In a loan, the borrower initially receives or borrows an amount of money, called the principal, from the lender, and is obligated to pay back or repay an equal amount of money to the lender at a later time. Typically, the money is paid back in regular installments, or partial repayments, where each installment is the same amount. The loan is generally provided at a cost, referred to as interest on the debt, which provides an incentive for the lender to engage in the loan.

In 2007, over 26,000,000 applications were filed for loans totaling over 5 trillion dollars, many of which were subprime mortgages. The subprime mortgage crisis is an ongoing financial crisis triggered by a dramatic rise in mortgage delinquencies and foreclosures in the United States, with major adverse consequences for banks and financial markets around the globe. The crisis, which has its roots in the closing years of the 20th century, became apparent in 2007 and has exposed pervasive weaknesses in financial industry regulation and the global financial system.

As can be seen, there is a need for a method of loan repayment that has flexibilities that will benefit both the lender and the borrower.

### SUMMARY OF THE INVENTION

In one aspect of the present invention, a computer implemented method for calculating loan repayment schedule, comprises receiving data associated with an initial principal loan amount, an interest rate, and a length of loan (term); processing the data using a processor to determine a periodic minimum payment toward the initial principal and the interest, and when the minimum periodic payment is made, a new principal balance is determined by subtracting payment toward principal from the initial principal loan amount, and when a payment in excess of the minimum periodic payment is paid, the new principal balance is calculated by subtracting the excess payment and the payment toward principal from the minimum periodic payment from the initial principal; and recalculating a new minimum periodic payment based on the remaining time and balance of the loan.

In another embodiment of the present invention, a data processing apparatus for calculating loan repayment schedule, comprises means for receiving data associated with an initial principal loan amount, an interest rate, and a length of loan term; a storage medium adapted to store the data received by the data receiving means; and a data processor for determining a periodic minimum payment toward the initial principal and the interest, and when the minimum periodic payment is made, a new principal balance is determined by subtracting payment toward principal from the initial principal loan amount, and when a payment in excess of the minimum periodic payment is paid, the new principal balance is calculated by subtracting the excess payment and the payment toward principal from the minimum periodic payment from the initial principal, and a new minimum periodic payment is calculated based on remaining time and remaining principal balance.

These and other features, aspects and advantages of the present invention will become better understood with reference to the following drawings, description and claims.

### BRIEF DESCRIPTION OF THE DRAWINGS

FIG. 1 shows a flowchart for an exemplary payment process;

FIG. 2 shows a flowchart for an exemplary calculation process;

FIG. 3 shows exemplary steps to achieve the modified amortization schedule of FIG. 4;

FIG. 4 shows an exemplary amortization schedule with additional principal pay down resulting in the minimum periodic payments being reduced.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system and method for a loan repayment schedule with decreasing minimum payments. An exemplary embodiment of the present invention may provide an alternative form of a loan repayment where, for example, payment of funds above a scheduled periodic payment may contribute to lowering a minimum periodic payment thus, easing financial pressures on a borrower.

It will be understood that the system and method may incorporate the use of a computer, a network of computers, or servers to transact exemplary steps disclosed herein. Additionally, exemplary embodiments of the present invention may further store, read, and transmit data from a computer readable medium such as a hard disk, a floppy disk, flash memory, optical discs, and processor chips.

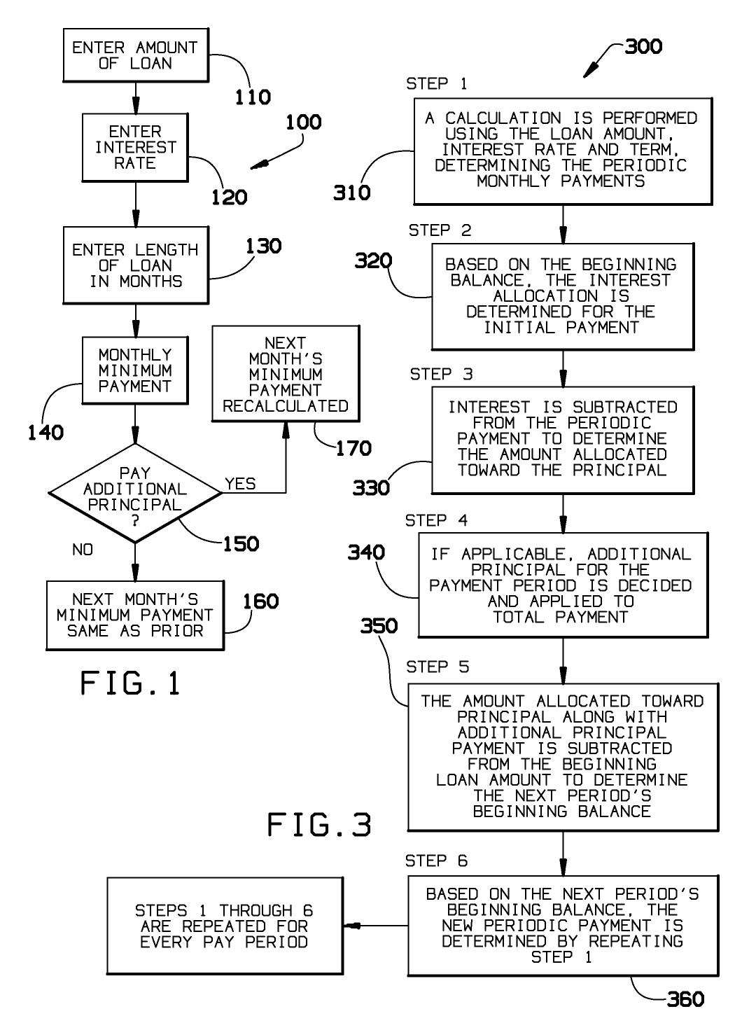

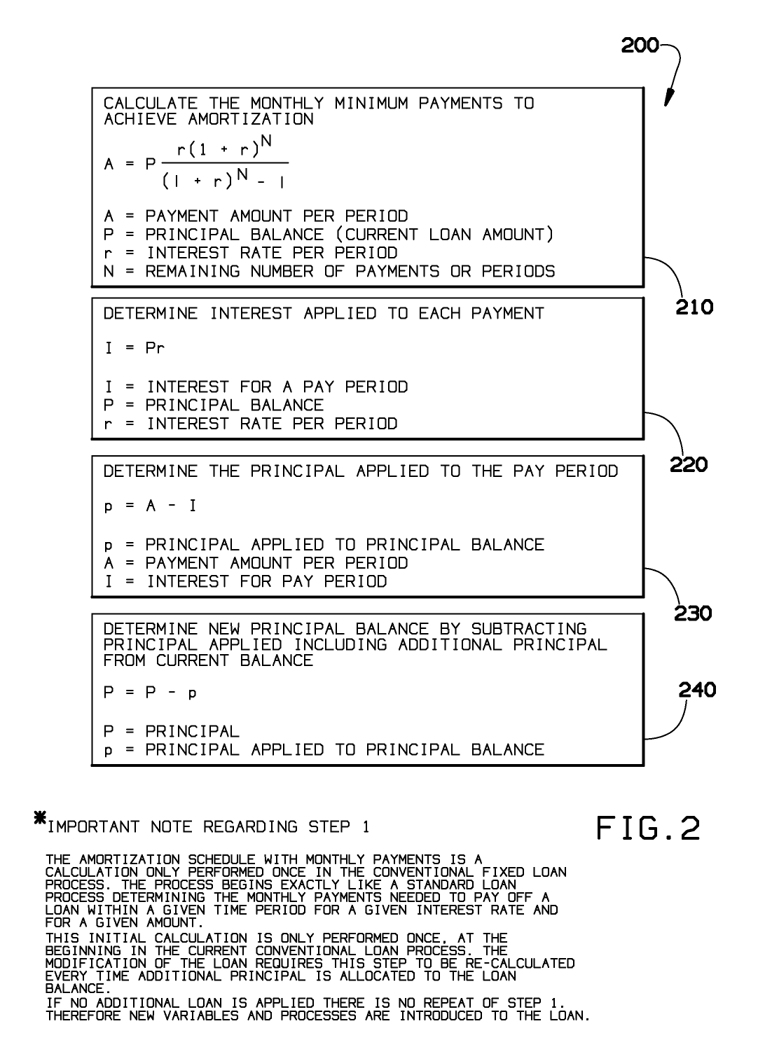

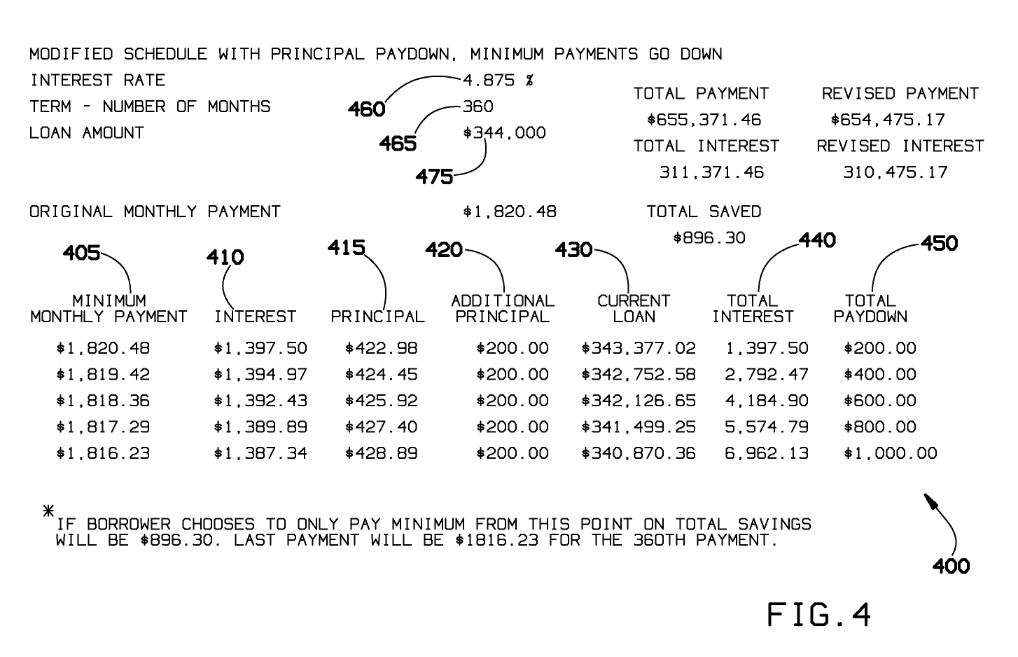

Referring to FIGS. 1 and 4, an exemplary embodiment of a method 100 of processing a loan repayment according to an exemplary amortization schedule 400 may be illustrated in general according to the following series of steps. In step 110, a loan amount 475 remaining to be repaid may be entered. In step 120, an interest rate 460 associated with the loan may be entered. In step 130, a length of the loan, a loan term 465, may be entered. It will be understood that the data entered in steps 110, 120, and 130, may be executed at different periods of the loan. The information entered in steps 110, 120, and 130 may be used to calculate a monthly minimum payment 405 in step 140. In step 150, a borrower may decide whether or not to pay funds above the principal amount 415 due in the monthly minimum payment 405. If the borrower decides not to include funds contributing additional principal to the minimum monthly payment 405, then in step 160, the next month's minimum monthly payment 405 may be calculated to be the same as the minimum monthly payment calculated in step 140. Otherwise, if additional principal funds 420 are paid toward the principal 415, then in step 170, the next month's minimum monthly payment 405 may be recalculated to reduce the amount of the payment due.

Calculation of elements associated with the loan repayment process 100 may be performed according to an exemplary calculation process 200. In step 210, the minimum monthly payment may be calculated in general according to the exemplary equation:

$$A = P \frac{{r ( 1 + r )}^{n}}{{( 1 + r )}^{n} - 1}$$

where A may equal a payment amount per period; P may equal a principal balance remaining on the loan; r may equal an interest rate for a period; and n may equal a remaining number of payments or periods on the loan. In step 220, an interest I may be calculated according to the following equation:

I=Pr

where I may equal the interest for a pay period; P may equal the principal balance remaining on the loan; and r may equal an interest rate for a period. In step 230, the principal balance remaining on the loan may be determined as calculated according to the exemplary equation:

p=A−I

where p may equal a current principal amount applied to the principal balance; A may equal a payment amount paid per period calculated in step 210; and I an interest rate for a period calculated in step 220. In step 240, a new principal balance P* may be determined and calculated according to the following exemplary equation:

P*=P−p

where P may equal a principal balance remaining on the loan and p may equal a current principal amount applied to the principal balance as calculated in step 230. Thus, in step 240, the new principal balance P* may be determined by subtracting the principal applied to the principal balance. According to an exemplary embodiment of the present invention, the principal applied to the principal balance may include additional principal funds not scheduled to be paid. Steps 210-240 are repeated at each pay period.

Referring now to FIGS. 3 and 4, another exemplary embodiment of the present invention may be described in method 300 according to the following series of steps. In step 310, a calculation may be performed using the loan amount, interest rate, and term, determining fixed monthly payments. In step 320 an interest allocation may be determined based on the beginning balance 475 or current loan 430 depending on the stage of the loan. In step 330, interest 410 may be subtracted from the monthly minimum payment 405 to determine the amount allocated toward the principal 415. In step 340, additional principal 420 for the payment period may be applied in addition to the minimum monthly payment 405 as a total payment. In step 350, the amount allocated toward principal from the total monthly payment, including the additional principal 420, may be subtracted from the current loan amount 430 to determine the next period's current loan amount 430. In step 360, the new minimum payment 405 is determined by recalculating the new current loan amount 430 based on the remaining term 465. Interest 410 is calculated once again but now it may be based on the new current loan amount 430 which may be accelerated lower by virtue of the additional principal 420 and thus, the minimum monthly payment 405 may be lowered.

It should be understood, of course, that the foregoing relates to exemplary embodiments of the invention and that modifications may be made without departing from the spirit and scope of the invention as set forth in the following claims.

I claim:

1. A computer implemented method for calculating loan repayment schedule, comprising:
receiving data associated with an initial principal loan amount, an interest rate, and a length of loan term;
processing the data using a processor to determine a periodic minimum payment toward the initial principal and the interest, and when the minimum periodic payment is made, a new principal balance is determined by subtracting payment toward principal from the initial principal loan amount, and when a payment in excess of the minimum periodic payment is paid, the new principal balance is calculated by subtracting the excess principal payment and the payment toward principal from the minimum periodic payment from the initial principal;
and recalculating a new minimum periodic payment based on remaining time and balance of the loan.

2. The method of claim 1, wherein the minimum periodic payment remains fixed, and the recalculation of the new principal upon payment of the minimum periodic payment and the excess principal payment reduces the length of loan.

3. The method of claim 1, wherein the minimum periodic payment is reduced over the length of loan upon payment of the minimum periodic payment and the excess principal payment.

4. A data processing apparatus for calculating loan repayment schedule, comprising:
means for receiving data associated with an initial principal loan amount, an interest rate, and a length of loan term; a storage medium adapted to store the data received by the data receiving means; and
a data processor for determining a periodic minimum payment toward the initial principal and the interest, and when the minimum periodic payment is made, a new principal balance is determined by subtracting payment toward principal from the initial principal loan amount, and when a payment in excess of the minimum periodic payment is paid, the new principal balance is calculated by subtracting the excess principal payment and the payment toward principal from the minimum periodic payment from the initial principal, and further recalculating a new minimum periodic payment based on remaining term and balance of the loan.

5. The apparatus of claim 4, wherein the processor determines a fixed minimum periodic payment, and the recalculation of the new principal upon payment of the minimum periodic payment and the excess principal payment reduces the length of loan.

6. The apparatus of claim 4, wherein the processor reduces the minimum periodic payment over the length of loan upon payment of the minimum periodic payment and the excess principal payment.
